(19) United States
(12) Patent Application Publication
(10) Pub. No.: US 2012/0093003 A1
(43) Pub. Date: Apr. 19, 2012

(54) TESTING AND PAIRING SYSTEM FOR USE IN WIRELESS PERIPHERAL DEVICE PRODUCTION PROCESS

(75) Inventor: Chien-Nan Lin, Taipei (TW)

(73) Assignee: PRIMAX ELECTRONICS LTD., Taipei (TW)

(21) Appl. No.: 12/984,430

(22) Filed: Jan. 4, 2011

(30) Foreign Application Priority Data
Oct. 15, 2010 (TW) 099135186

(51) Int. Cl. G06F 3/01; H04W 88/02

(52) U.S. Cl. 370/242

(57) ABSTRACT

A testing and paring system is used in a wireless peripheral device production process. The testing and paring system includes a wireless receiver, plural wireless input devices and a jig. The jig transmits respective packets to the wireless receiver and the plural wireless input devices through the pairing channel, and receives respective response signals from the wireless receiver and the plural wireless input devices. If the response signals from the wireless receiver and the plural wireless input devices are successfully received by the jig, the wireless receiver and the plural wireless input devices are considered to have normal functions.

### FIELD OF THE INVENTION

The present invention relates to a testing and paring system for use in a wireless peripheral device production process, and more particularly to a testing and paring system for testing and pairing plural wireless input devices and a single wireless receiver in a wireless peripheral device production process.

### BACKGROUND OF THE INVENTION

FIG. 1 is a schematic diagram illustrating a simplified wireless peripheral device production line according to the prior art. This production line is disclosed in Taiwanese Patent Application No. 200920001. As shown in FIG. 1, the production line comprises a first testing station 11, a second testing station 12 and a pairing station 13. The first testing station 11 comprises a wireless input device 111 and a first testing unit 112. The second testing station 12 comprises a wireless receiver 121 and a second testing unit 122. The pairing station 13 comprises the wireless receiver 121 and the wireless input device 111.

The wireless input device 111 has the first testing code 111a, a pairing identification code 111b and a device identification code 111c. The first testing unit 112 also has the first testing code 111a. The wireless receiver 121 has a second testing code 121a and the pairing identification code 111b. The second testing unit 122 also has the second testing code 121a.

In the first testing station 11, by pressing a pairing button 112a of the first testing unit 112, the first testing code 111a is transmitted from the wireless input device 111 to the first testing unit 112 through a communication channel in a working band. After the first testing code 111a is received by the first testing unit 112, the first testing unit 112 issues a first response signal 113 to the wireless input device 111. The reception of the first response signal 113 by the wireless input device 111 indicates that the function of the wireless input device 111 is normal. Generally, the frequency of the working band is ranged between 2400 MHz and 2483.5 MHz.

In the second testing station 12, by pressing a pairing button 122a of the second testing unit 122, the second test code 121a is transmitted from the second testing unit 122 to the wireless receiver 121 through a pairing channel. After the second test code 121a is received by the wireless receiver 121, the wireless receiver 121 issues a second response signal 123 to the second testing unit 122. The reception of the second response signal 123 by the wireless receiver 121 indicates that the function of the wireless receiver 121 is normal. For example, the frequency of the pairing channel may be 2500 MHz.

After the wireless input device 111 and the wireless receiver 121 are considered to have normal functions, the wireless input device 111 and the wireless receiver 121 will be sent into the pairing station 13 to perform a pairing operation. In the pairing station 13, the operator allows the wireless input device 111 to issue the pairing identification code 111b and the device identification code 111c to the wireless receiver 121 through the paring channel, and allows the wireless receiver 121 to wait for receiving the pairing identification code 111b and the device identification code 111c. After the pairing identification code 111b and the device identification code 111c are received by the wireless receiver 121, the wireless receiver 121 issues a third response signal 131 to the wireless input device 111. Then, the pairing identification code 111b originally stored in the wireless receiver 121 is replaced with the device identification code 111c. In addition, the wireless receiver 121 is set to communicate with the wireless input device 111 through a specified communication channel of the working band. After the third response signal 131 is received by the wireless input device 111, the wireless input device 111 is set to communicate with the wireless receiver 121 through the specified communication channel.

From the above discussions, for pairing the wireless input device 111 and the wireless receiver 121 in the production line, the functions of the wireless input device 111 and the wireless receiver 121 should be firstly tested in the first testing station 11 and the second testing station 12, respectively. After the wireless input device 111 and the wireless receiver 121 are considered to have normal functions, the wireless input device 111 and the wireless receiver 121 will be sent into the pairing station 13 to perform a pairing operation, so that normal communication between the wireless input device 111 and the wireless receiver 121 is achieved.

The above wireless peripheral device production line is applied to a testing and paring system with a single wireless input device and a single wireless receiver in a wireless peripheral device production process. For testing and paring a wireless peripheral device product suite with plural wireless input devices and a single wireless receiver, the plural wireless input devices and the single wireless receiver are firstly tested one by one, and then the paring operations on the plural wireless input devices and the single wireless receiver are performed one by one. That is, the conventional testing and pairing method of the wireless peripheral device product suite is labor-intensive. As the number of wireless input device increases, the operating time of the production line is prolonged, and thus the production throughput is insufficient.

For solving the drawbacks encountered from the conventional wireless peripheral device production process, there is a need of providing a testing and paring system for simultaneously testing and pairing plural wireless input devices and a single wireless receiver in a wireless peripheral device production process.

### SUMMARY OF THE INVENTION

The present invention provides a testing and paring system for simultaneously testing and pairing plural wireless input devices and a single wireless receiver in a wireless peripheral device production process.

In accordance with an aspect of the present invention, there is provided a testing and paring system for use in a wireless peripheral device production process. The testing and paring system includes a wireless receiver, plural wireless input devices, and a jig. The wireless receiver and the plural wireless input devices have respective pairing identification codes. In addition, the wireless receiver and the plural wireless input devices transmit and receive data through a pairing channel. The jig includes an identification code generator and a wireless radio frequency module. The identification code generator is configured to generate a working identification code. The wireless radio frequency module is configured to transmit respective packets to the wireless receiver and the plural wireless input devices through the pairing channel and receive respective response signals from the wireless receiver and the plural wireless input devices. The contents of the packets include corresponding pairing identification codes of the wireless receiver and the plural wireless input devices, the working identification code and a working channel data. If the response signals are received by the wireless radio frequency module, the wireless receiver or the plural wireless input devices whose response signals are successfully transmitted are considered to have normal functions, and the pairing identification codes of the wireless receiver or the plural wireless input devices whose response signals are successfully transmitted are replaced with the working identification code, and the wireless receiver or the plural wireless input devices are set to communicate through the working channel. If the response signal of the wireless receiver or any of the plural wireless input devices is not received by the wireless radio frequency module, the wireless radio frequency module continuously issues the corresponding packet for several times within a predetermined time period, and if the response signal of the wireless receiver or the wireless input device is not received by the wireless radio frequency module within the predetermined time period, the wireless receiver or the wireless input device is considered to have an abnormal function.

In an embodiment, the working identification code includes plural communication identification codes, wherein each of the plural wireless input devices selects one of the plural communication identification codes to communicate with the wireless receiver.

In an embodiment, by decreasing power of the wireless radio frequency module of the jig, the interference between plural testing stations is minimized.

In an embodiment, the jig further includes plural light-emitting elements, a connecting port and a selection key. The plural light-emitting elements are used for indicating whether the plural wireless input devices are successfully paired or not. The connecting port is connected with the wireless receiver, so that electricity is transmitted to the wireless receiver through the connecting port. The selection key is used for setting the number of the wireless receiver and the plural wireless input devices.

In an embodiment, the plural wireless input devices include a wireless keyboard, a wireless mouse, a wireless remoter and a wireless communication device, or at least two of the wireless keyboard, the wireless mouse, the wireless remoter and the wireless communication device.

In an embodiment, the frequency of the working band is ranged between 2400 MHz and 2483.5 MHz.

In an embodiment, the frequency of the pairing channel is 2500 MHz.

In accordance with another aspect of the present invention, there is provided a testing and paring method for use in a wireless peripheral device production process. The testing and paring method includes the following steps. Firstly, a wireless receiver and plural wireless input devices enter a pairing mode. Then, a working identification code is generated. Then, respective packets are issued to the wireless receiver and the plural wireless input devices through a pairing channel, and respective response signals from the wireless receiver and the plural wireless input devices are received, wherein the contents of the packets comprise corresponding pairing identification codes of the wireless receiver and the plural wireless input devices, the working identification code and a working channel data. Then, a judging step is performed to judge whether the functions of the wireless receiver and the plural wireless input devices are normal. If the response signals are received, the wireless receiver or the plural wireless input devices whose response signals are successfully transmitted are considered to have normal functions, and the pairing identification codes of the wireless receiver or the plural wireless input devices whose functions are normal are replaced with the working identification code, and the wireless receiver or the plural wireless input devices are set to communicate through the working channel. If the response signal of the wireless receiver or any of the plural wireless input devices is not received by the wireless radio frequency module, the corresponding packet is continuously transmitted for several times within a predetermined time period. If the response signal is not received within the predetermined time period, the wireless receiver or the wireless input device is considered to have an abnormal function.

In an embodiment, the working identification code includes plural communication identification codes, wherein each of the plural wireless input devices selects one of the plural communication identification codes to communicate with the wireless receiver.

In an embodiment, the plural wireless input devices include a wireless keyboard, a wireless mouse, a wireless remoter and a wireless communication device, or at least two of the wireless keyboard, the wireless mouse, the wireless remoter and the wireless communication device.

In an embodiment, the frequency of the working band is ranged between 2400 MHz and 2483.5 MHz.

In an embodiment, the frequency of the pairing channel is 2500 MHz.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a simplified wireless peripheral device production line according to the prior art;

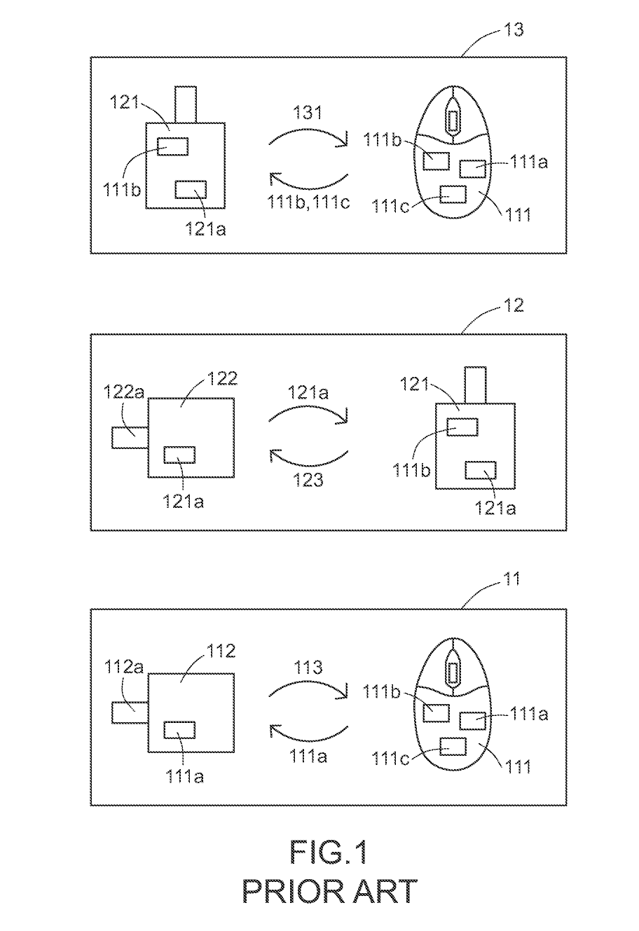

FIG. 2 is a schematic diagram illustrating the wireless peripheral devices of a testing and paring system according to an embodiment of the present invention;

FIG. 3 is a schematic block diagram illustrating a testing and paring system for use in a wireless peripheral device production process according to an embodiment of the present invention; and

FIG. 4 is a flowchart illustrating a testing and paring method for use in a wireless peripheral device production process according to an embodiment of the present invention.

### DETAILED DESCRIPTION OF THE PREFERRED EMBODIMENT

The present invention provides a testing and paring system for use in a wireless peripheral device production process according to an embodiment of the present invention. The testing and paring system may be applied to a wireless peripheral device product suite.

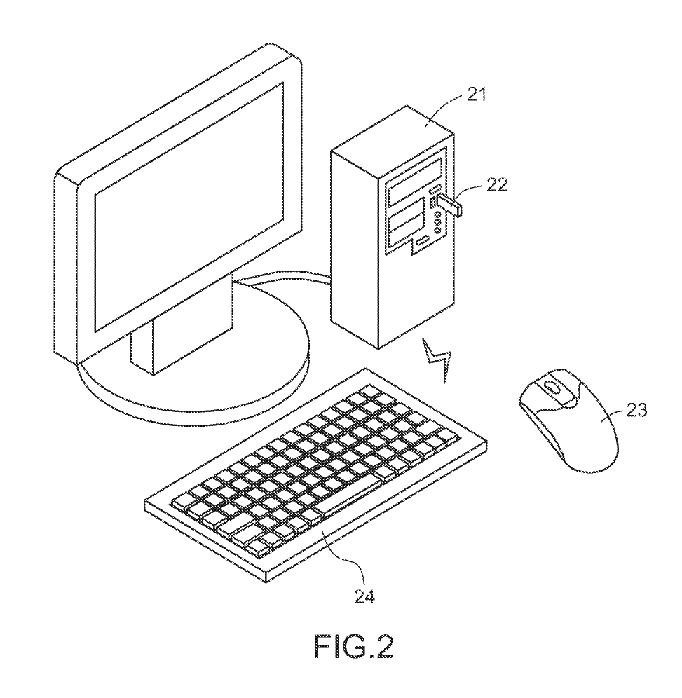

FIG. 2 is a schematic diagram illustrating the wireless peripheral devices of a testing and paring system in a wireless peripheral device production process according to an embodiment of the present invention. For example, the wireless peripheral devices comprise plural wireless input devices and a wireless receiver. The number of the wireless input devices is not restricted. That is, the wireless peripheral devices comprises two or more wireless input devices and a wireless receiver. Hereinafter, the present invention will be illustrated by referring to a testing and paring system with two wireless input devices and a wireless receiver.

In FIG. 2, a computer 21, a wireless receiver 22, a first wireless input device 23 and a second wireless input device 24 are shown. The common wireless input device includes for example a wireless keyboard, a wireless mouse, a wireless remoter, a wireless communication device, and so on. In this embodiment, the first wireless input device 23 is a wireless mouse, and the second wireless input device 24 is a wireless keyboard. When the wireless receiver 22 is connected with the computer 21 to receive electricity from the computer 21, the wireless receiver 22 is enabled. Consequently, the first wireless input device 23 and the second wireless input device 24 will automatically and wirelessly communicate with the wireless receiver 22 according to a communication identification code. For assuring normal functions of the wireless peripheral device product suite and communication between the first wireless input device 23 and the second wireless input device 24 and the wireless receiver 22, a testing and pairing operation needs to be performed in the wireless peripheral device production process.

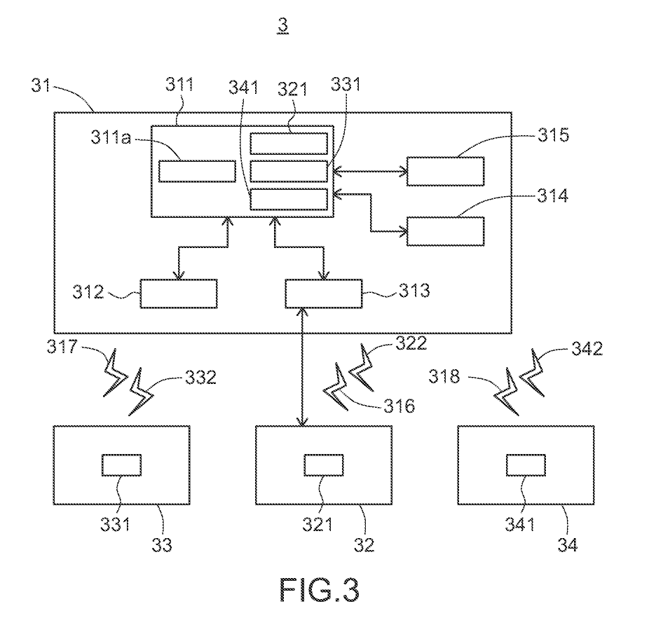

FIG. 3 is a schematic block diagram illustrating a testing and paring system for use in a wireless peripheral device production process according to an embodiment of the present invention. As shown in FIG. 3, the testing and paring system 3 for use in a wireless peripheral device production process comprises a jig 31, a wireless receiver 32, a first wireless input device 33 and a second wireless input device 34. The jig 31 comprises a processor 311, a wireless radio frequency module 312, a connecting port 313, a selection key 314 and plural light-emitting elements 315. The processor 311 comprises an identification code generator 311a. The wireless receiver 32, the first wireless input device 33 and the second wireless input device 34 have respective pairing identification codes 321, 331 and 341. In addition, the pairing identification codes 321, 331 and 341 are also stored in the jig 31.

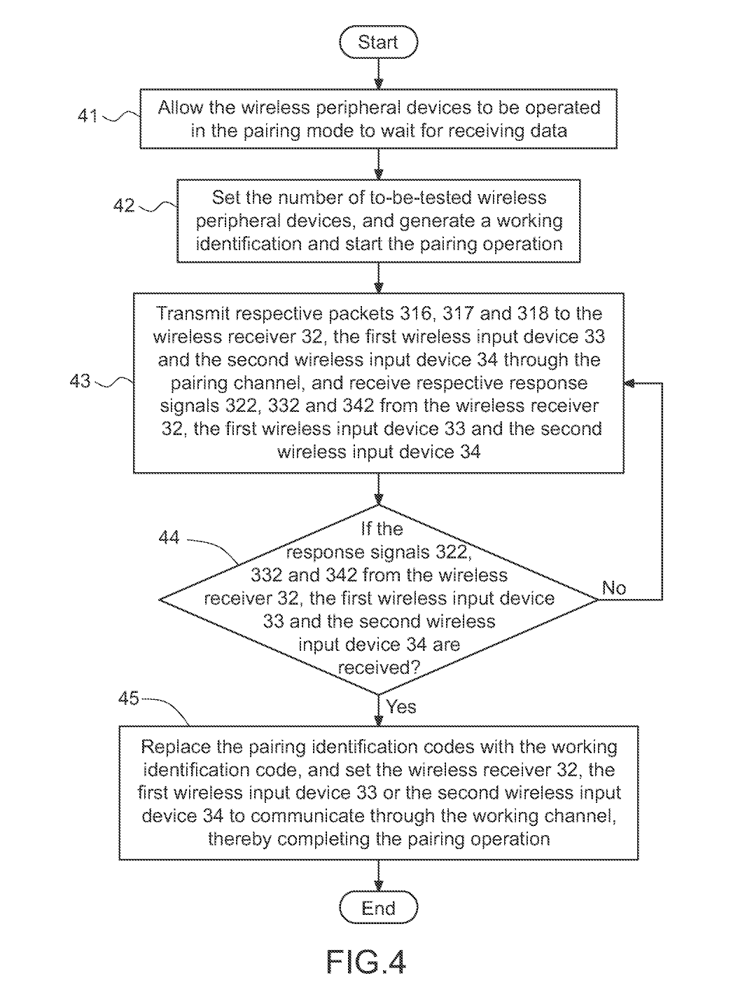

FIG. 4 is a flowchart illustrating a testing and paring method for use in a wireless peripheral device production process according to an embodiment of the present invention.

In the step 41, the wireless peripheral devices 32, 33 and 34 are operated in the pairing mode to wait for receiving data.

For example, by pressing specified pairing buttons (not shown) of the to-be-tested wireless peripheral devices 32, 33 and 34, the wireless receiver 32, the first wireless input device 33 and the second wireless input device 34 enter the pairing mode to wait for receiving data from the jig 31. In the pairing mode, the wireless receiver 32, the first wireless input device 33 and the second wireless input device 34 transmit and receive data through a pairing channel. For example, the frequency of the pairing channel may be 2500 MHz.

In the step 42, the number of the to-be-tested wireless peripheral devices is set through the jig 31, and then the working identification is generated to start the pairing operation.

Via the selection key 314 of the jig 31, the operator may select the number of the to-be-tested wireless peripheral devices. In this embodiment, there are three to-be-tested wireless peripheral devices, i.e. the wireless peripheral devices 32, 33 and 34. Then, the jig 31 is activated to be operated in the pairing mode. In the pairing mode, the identification code generator 311a of the jig 31 generates a working identification code, and the wireless radio frequency module 312 is set to transmit and receive data through the pairing channel. The working identification code includes plural communication identification codes. In this embodiment, the communication identification code consists of five bytes (e.g. 0.0.0.0.255). After the settings are completed, the wireless radio frequency module 312 of the jig 31 is ready for transmitting data to the wireless receiver 32, the first wireless input device 33 and the second wireless input device 34. Moreover, since no built-in power source (e.g. a battery) is installed within the wireless receiver 32 to power the wireless receiver 32, the wireless receiver 32 should be connected with the connecting port 313 to receive electricity from the jig 31. However, the wireless receiver 32 still wirelessly communicates with the jig 31.

In the step 43, a pairing operation is performed.

For example, three packets 316, 317 and 318 are respectively transmitted to the wireless receiver 32, the first wireless input device 33 and the second wireless input device 34 through the pairing channel. Since the wireless radio frequency module 312 communicates with the wireless receiver 32, the first wireless input device 33 and the second wireless input device 34 according to the pairing identification codes 321, 331 and 341, respectively, the packets 316, 317 and 318 may have corresponding pairing identification codes 321, 331 and 341. In addition, each of the packets 316, 317 and 318 further includes the working identification code and the working channel data. In this embodiment, the frequency of the working band is ranged between 2400 MHz and 2483.5 MHz.

It is noted that the pairing identification codes 321, 331 and 341 fail to be used as the identification codes in the common usage state. For example, the pairing identification code 321 of the wireless receiver 32 is AAH.AAH.AAH.AAH.A8H, and the pairing identification code 321 can only be used for communication in the production line. In other words, it is necessary to perform a pairing operation to replace the pairing identification codes 321, 331 and 341 of the wireless receiver 32, the first wireless input device 33 and the second wireless input device 34 with the practical working identification code.

After the packets 316, 317 and 318 are respectively transmitted from the wireless radio frequency module 312 to the wireless receiver 32, the first wireless input device 33 and the second wireless input device 34 through the pairing channel, the wireless radio frequency module 312 starts to wait for receiving the response signals 322, 332 and 342 from the wireless receiver 32, the first wireless input device 33 and the second wireless input device 34.

Then, depending on whether the response signal 322, 332 and 342 are received or not, the step 44 is performed to judge whether the functions of the wireless receiver 32, the first wireless input device 33 and the second wireless input device 34 are normal.

For example, if the response signal 322, 332 and 342 from the wireless receiver 32, the first wireless input device 33 and the second wireless input device 34 are successfully received by the wireless radio frequency module 312, the wireless receiver 32, the first wireless input device 33 and the second wireless input device 34 are considered to have normal functions. Once the functions of the wireless receiver 32, the first wireless input device 33 and the second wireless input device 34 are normal, the step 45 is performed to store the working identification code into the wireless receiver 32, the first wireless input device 33 and the second wireless input device 34 to replace the pairing identification codes 321, 331 and 341 with the working identification code. In this situation, the wireless receiver 32, the first wireless input device 33 and the second wireless input device 34 are set to communicate through the working channel. Meanwhile, the pairing operation is completed.

On the other hand, if any of the response signal 322, 332 and 342 is not received by the wireless radio frequency module 312, the step 43 will be repeatedly performed to transmit the corresponding packet to the corresponding wireless peripheral device for several times within a predetermined time period. For example, if the response signal 322 from the wireless receiver 32 is not received, the step 43 will be repeatedly performed to transmit the packet 316 to the wireless receiver 32 for several times within a predetermined time period (e.g. 4 seconds). If the response signal 322 from the wireless receiver 32 is successfully received within the predetermined time period, the step of transmitting the packet 316 is stopped, and then the pairing operation of the wireless receiver 32 is performed. If the response signal 322 from the wireless receiver 32 fails to be successfully received within the predetermined time period, the wireless receiver 32 is considered to have an abnormal function.

After the testing and pairing operations of all wireless peripheral devices are completed, the light-emitting elements 315 of the jig 31 will indicate whether the functions of the wireless receiver 32, the first wireless input device 33 and the second wireless input device 34 are normal or not. In such way, the operator may decide whether the abnormal devices are tested and paired again or the abnormal devices are changed, and then the testing and pairing operations are performed again.

Moreover, the working identification code includes plural communication identification codes. After the testing and pairing operations of the wireless receiver 32, the first wireless input device 33 and the second wireless input device 34 are completed, these wireless peripheral devices may be introduced to the market. If the user wants to use the wireless peripheral device product suite, the wireless receiver 32 is firstly connected with the computer to receive electricity from the computer. Afterwards, the first wireless input device 33 and the second wireless input device 34 are automatically set to communicate with the wireless receiver 32 through the working channel according to respective communication identification codes. For example, the communication identification code of the first wireless input device 33 is 0.0.0.1.0, and the communication identification code of the second wireless input device 34 is 0.0.0.1.1.

From the above description, the testing and paring system of the present invention utilizes a jig for automatically testing and pairing plural wireless peripheral devices. After the number of to-be-tested wireless peripheral devices is selected and the jig is activated, the process of testing and paring the wireless peripheral device product suite can be completed once. As a consequence, the testing and paring method of the present invention is labor-saving, and the production throughput is enhanced. Moreover, by decreasing power of the wireless radio frequency module of the jig, the interference between plural testing stations will be minimized without adversely affecting the operating efficiency of respective testing stations. Under this circumstance, the production throughput is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A testing and paring system for use in a wireless peripheral device production process, said testing and paring system comprising:
a wireless receiver and plural wireless input devices, wherein said wireless receiver and said plural wireless input devices have respective pairing identification codes, and said wireless receiver and said plural wireless input devices transmit and receive data through a pairing channel; and
a jig comprising an identification code generator and a wireless radio frequency module, wherein said identification code generator is configured to generate a working identification code, and said wireless radio frequency module is configured to transmit respective packets to said wireless receiver and said plural wireless input devices through said pairing channel and receive respective response signals from said wireless receiver and said plural wireless input devices, wherein the contents of said packets comprise corresponding pairing identification codes of said wireless receiver and said plural wireless input devices, said working identification code and a working channel data,
wherein if said response signals are received by said wireless radio frequency module, said wireless receiver or said plural wireless input devices whose response signals are successfully transmitted are considered to have normal functions, and said pairing identification codes of said wireless receiver or said plural wireless input devices whose response signals are successfully transmitted are replaced with said working identification code, and said wireless receiver or said plural wireless input devices are set to communicate through said working channel,
wherein if said response signal of said wireless receiver or any of said plural wireless input devices is not received by said wireless radio frequency module, said wireless radio frequency module continuously issues said corresponding packet for several times within a predetermined time period, and if said response signal of said wireless receiver or said wireless input device is not received by said wireless radio frequency module within said predetermined time period, said wireless receiver or said wireless input device is considered to have an abnormal function.

2. The testing and paring system according to claim 1 wherein said working identification code includes plural communication identification codes, wherein each of said plural wireless input devices selects one of said plural communication identification codes to communicate with said wireless receiver.

3. The testing and paring system according to claim 1 wherein by decreasing power of said wireless radio frequency module of said jig, the interference between plural testing stations is minimized.

4. The testing and paring system according to claim 1 wherein said jig further comprises:
plural light-emitting elements for indicating whether said plural wireless input devices are successfully paired or not;
a connecting port to be connected with said wireless receiver, so that electricity is transmitted to said wireless receiver through said connecting port; and
a selection key for setting the number of said wireless receiver and said plural wireless input devices.

5. The testing and paring system according to claim 1 wherein said plural wireless input devices comprise a wireless keyboard, a wireless mouse, a wireless remoter and a wireless communication device, or at least two of said wireless keyboard, said wireless mouse, said wireless remoter and said wireless communication device.

6. The testing and paring system according to claim 1 wherein the frequency of said working band is ranged between 2400 MHz and 2483.5 MHz.

7. The testing and paring system according to claim 1 wherein the frequency of the pairing channel is 2500 MHz.

8. A testing and paring method for use in a wireless peripheral device production process, said testing and paring method comprising steps of:
(A) allowing a wireless receiver and plural wireless input devices to enter a pairing mode;
(B) generating a working identification code;
(C) issuing respective packets to said wireless receiver and said plural wireless input devices through a pairing channel, and receiving respective response signals from said wireless receiver and said plural wireless input devices, wherein the contents of said packets comprise corresponding pairing identification codes of said wireless receiver and said plural wireless input devices, said working identification code and a working channel data; and
(D) judging whether the functions of said wireless receiver and said plural wireless input devices are normal, wherein if said response signals are received, said wireless receiver or said plural wireless input devices whose response signals are successfully transmitted are considered to have normal functions, said pairing identification codes of said wireless receiver or said plural wireless input devices whose functions are normal are replaced with said working identification code, and said wireless receiver or said plural wireless input devices are set to communicate through said working channel, wherein if said response signal of said wireless receiver or any of said plural wireless input devices is not received by said wireless radio frequency module, said corresponding packet is continuously transmitted for several times within a predetermined time period, and if said response signal is not received within said predetermined time period, said wireless receiver or said wireless input device is considered to have an abnormal function.

9. The testing and paring method according to claim 8 wherein said working identification code includes plural communication identification codes, wherein each of said plural wireless input devices selects one of said plural communication identification codes to communicate with said wireless receiver.

10. The testing and paring method according to claim 8 wherein said plural wireless input devices comprise a wireless keyboard, a wireless mouse, a wireless remoter and a wireless communication device, or at least two of said wireless keyboard, said wireless mouse, said wireless remoter and said wireless communication device.

11. The testing and paring method according to claim 8 wherein the frequency of said working band is ranged between 2400 MHz and 2483.5 MHz.

12. The testing and paring method according to claim 8 wherein the frequency of the pairing channel is 2500 MHz.
